(19) United States
(12) Patent Application Publication
(10) Pub. No.: US 2006/0274729 A1
(43) Pub. Date: Dec. 7, 2006

(54) Apparatus and method for connecting a voice over IP telephone subscriber to the 911 emergency network

(76) Inventor: Michael Self, Fort Lauderdale, FL (US)

Correspondence Address: ROBERT M. SCHWARTZ, P.A., P.O. BOX 221470, HOLLYWOOD, FL, 33022, US

(21) Appl. No.: 11/332,581

(22) Filed: Jan. 13, 2006

Related U.S. Application Data
(60) Provisional application No. 60/687,402, filed on Jun. 3, 2005.

(51) Int. Cl. H04L 12/66; H04L 12/56

(52) U.S. Cl. 370/352; 370/401

(57) ABSTRACT

It is accordingly an object of the invention to provide a device to connect a VoIP telephone subscriber to connect a communication network, in order to place a telephone call, which may be an emergency call. The device includes determination circuitry to determine whether the telephone call is to be placed over a high speed IP data network, or via another communications network. Upon making a determination, the call is placed over the determined network.

### PRIORITY

The present application claims priority from co-pending U.S. provisional patent application Ser. No. 60/687,402, Filed on Jun. 3, 2005 and entitled APPARATUS AND METHOD FOR CONNECTING A VOICE OVER IP TELEPHONE SUBSCRIBER TO THE 911 EMERGENCY NETWORK.

### BACKGROUND OF THE INVENTION

1. Field of the Invention

The invention relates to an apparatus and method of connecting an IP telephone subscriber to the 911 emergency network, and more particularly to, in the absence of an IP network, connecting the IP telephone subscriber to the 911 emergency network through another type of communication network.

2. Description of the Related Art

Voice-over-Internet-Protocols or “VoIP” telephone systems have recently become more widely available, to transmit voice conversations over a data network using the Internet Protocol, rather than through conventional telephone switching networks. Such data networks include the Internet and/or corporate Intranets, connected to using such interfaces as Local-Area-Networks (“LANs”), Wide-Area-Networks (“WANs”), as well as other means of connection. A recent article estimates that there are about 3.6 million VoIP telephone users currently in the United States.

It has been found that limitations to using VoIP telephone systems arise when it becomes necessary to place an emergency telephone call using the “₉₁₁” phantom telephone exchange number. At present, many, if not most, VoIP telephone subscribers and service providers do not have the ability to dial a “911” call on their VoIP telephones and establish a connection with the correct “911” public service (or safety) answering point (“PSAP”). Further, a problem arises when the VoIP telephone is the subscriber's only means of communication, and the data network, VoIP network, and/or VoIP provider through which the subscriber communicates is unreachable, or down.

U.S. Patent Application Publication No. 2003/0096589 to Crandall et al., discloses a wireless peripheral device for allowing an IP softphone to place calls to a PSAP. In Crandall, upon detecting the origination of an emergency call to a PSAP, an IP softphone places the call over a cellular network, rather than utilizing data communication. The IP softphone of Crandall is disclosed as including a personal computer (PC) that provides overall control for the softphone. The Crandall reference does not disclose the use of any device other than an IP softphone, contained on a PC, for making telephone calls. Crandall additionally does not disclose placing emergency calls on any network other than the cellular network.

U.S. Pat. No. 6,154,658 to Caci discloses a vehicle information and safety control system (“VISC”) including a main computer at a vehicle fleet headquarters with access over a CDPD data to a CDPD network (or its equivalent) data transceiver located in a vehicle. In Caci, a low bit rate digital speech vocoder is used to format speech into a low bit rate data stream for transmission via the CDPD data stream or the circuit switched cellular data stream. See Col. 9 of Caci, line 64-Col. 10, line 33. In Caci, the vehicle including the CDPD network data transceiver additionally includes a cellular radio communication transceiver. In emergency situations, the VISC of Caci will make an analog connection to the PSAP using 911 or other reserved emergency number. Caci further discloses, in col. 9, lines 57-63, that “in an emergency situation, CDPD would be used either alone, or in conjunction with circuit switched cellular. In some areas, circuit switched cellular may be the only available communications. The VISC system is expected to recognize such a situation and to enable the best or most appropriate communications operating mode.” Caci does not disclose a device for transmitting telephone data packets over the Internet. Rather, in Caci, the CDPD modem of the vehicle can only communicate with the CDPD modem of the headquarters computer. Further, Caci does not disclose a device or system for transmitting telephone data packets on a high bit rate data stream.

What is needed is a system that can reliably connect a VoIP subscriber to a PSAP when making an emergency “911” telephone call. What is additionally needed is system that can connect a VoIP subscriber to a PSAP, even when the data network and/or VoIP service with which the VoIP subscriber communicates is unreachable. What is further needed is a VoIP device that can be used to make a determination that a path to the PSAP using the VoIP service and/or device is unavailable, and connect the VoIP subscriber to the proper PSAP, using another communication network.

### SUMMARY OF THE INVENTION

It is accordingly an object of the invention to provide a device to connect a VoIP telephone subscriber with another communication network, in order to place a telephone call. In one particular embodiment, a device is used to connect a VoIP telephone subscriber with another communication network in order to make an emergency call, i.e., to a phantom telephone number such as “911”. The device includes determination circuitry to determine whether the telephone call is to be placed over an IP data network, or via another communications network. Upon making a determination, an emergency call is placed over the determined network.

Other features which are considered as characteristic for the invention are set forth in the appended claims.

Although the invention is illustrated and described herein as embodied in an Apparatus And Method For Connecting A Voice Over IP Telephone Subscriber To A 911 Emergency Network, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

FIG. 1 is a block diagram of system in accordance with one particular embodiment of the present invention.

FIG. 2 is a block diagram of a device in accordance with one particular embodiment of the present invention, which can be used in a system, such as illustrated in FIG. 1.

FIG. 3 is a flow diagram of a method of using a system, in accordance with one particular embodiment of the present invention.

FIG. 4 is a flow diagram of another method of using a system, in accordance with one particular embodiment of the present invention.

FIG. 5 is a flow diagram of a further method of using a system, in accordance with one particular embodiment of the present invention.

FIG. 6 is a flow diagram of another method of using a system, in accordance with one particular embodiment of the present invention.

### DESCRIPTION OF THE PREFERRED EMBODIMENTS

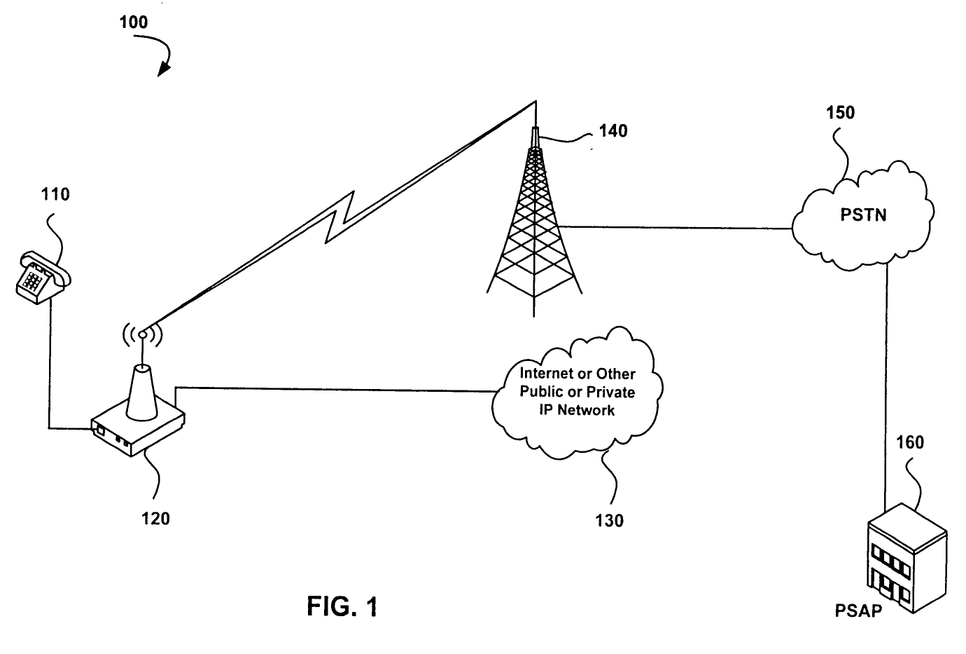

Referring now to the figures of the drawing in detail and first, particularly, to FIG. 1 thereof, there is seen a block diagram of a system 100 for connecting a voice over IP telephone subscriber to the 911 emergency network. System 100 includes a user telephone 110 connected, in this case by wire, to the communications device 120. The telephone device 110 is used to provide voice signals from the user. Additionally the telephone device 110 can include a user interface, from which a user may enter an input, such as the telephone number the user wishes to dial or, as will be discussed herebelow, an emergency code.

In the present embodiment, The communications device 120 includes the circuitry necessary to both: 1) prepare and send voice communication data for transmission over an IP network; and 2) transmit voice telephone communications over a second type of communications network, such as the established cellular telephone network. Note that, although the term “circuitry” is used throughout to describe particular components or modules of the system, such components are, in actuality, a combination of circuitry and software that performs a desired function. As such, the term “circuitry” is meant to encompass not only the circuitry that performs a function, but the software that controls such performance.

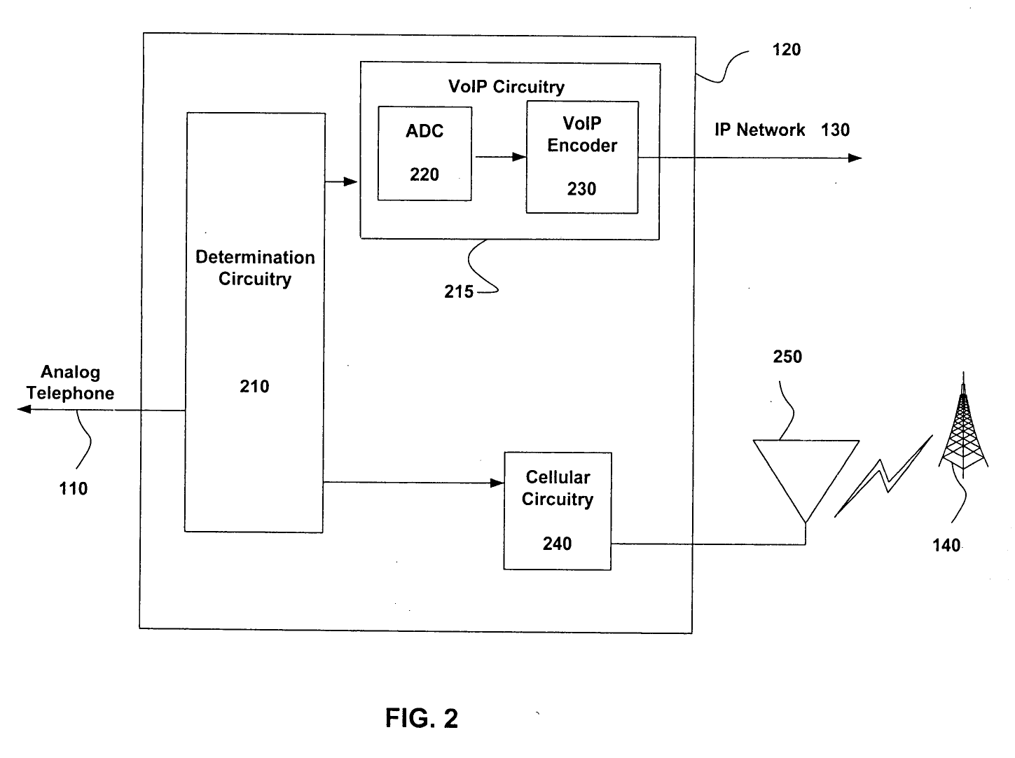

As will be discussed more below, in connection with FIGS. 2-6, the communications device 120 of the present embodiment further includes determination circuitry for determining certain conditions or events. Under certain normal conditions, the communications device 120 is connected to transmit, at high bit rates, packetized voice communication data received from the user telephone 110 over a data communications network 130. Such high bit rates can be achieved by connection of the data communications network 130 to the data network using a broadband connection, for example, by using existing DSL or cable modem service. Additionally, although shown in FIG. 1 to be a wired connection between communications device 120 and the data network 130, such a connection can additionally be provided using wireless means, such as by using the IEEE 802.11 wireless LAN protocol (WIFI) or the IEEE 802.16 (WiMax) protocol.

The data network 130, with which the communications device 120 connects to send digitized voice packets, formatted in accordance with the VoIP protocol, is most preferably the Internet. Advantageously, connection to the Internet provides nearly unlimited range of communication between the communication device 120 and other parties. However, other public or private data communications networks may be interfaced with the communications device 120.

Communications device 120 additionally includes a mechanism with which another communications network can be accessed. For example, in the embodiment of FIG. 1, the communications device 120 includes a cellular modem chip, or other type of radio modem circuitry, that enables the voice telephone information from the telephone 110 to be broadcast over the existing cellular or mobile telephone network. As shown in FIG. 1, the communications device 120 communicates wirelessly to the local cell or radio tower 140, which connects the call to the mobile telephone operator, transceiver and network. For example, the communication device 120 can utilize CDMA, TDMA or GSM to communicate with the mobile telephone network. From the mobile/cellular network, the 911 telephone call is routed to a PSAP 160, via the public switched telephone network PSTN 150. One advantage to such a communication is that, under current regulatory law, all mobile telephone providers must connect 911 calls to the PSAP, even if the originator of the phone call does not have account with the local mobile phone provider. As such, use of the data communications device 120 will ensure that the 911 emergency call, originating from the telephone 110, is completed.

Referring to FIG. 2, there is shown a block diagram of one particular embodiment of the data communication device 120. The communication device 120 of the instant embodiment connects between the users telephone 110 and the IP network 130. Note, however, that the device 120 may, if desired, be incorporated into, or combined with, the telephone 110.

In order to initiate a VoIP telephone session over an IP network, the communication device 120 includes circuitry and software necessary to convert analog voice signals to packet data, packetizing for IP transmission and software to affect signaling for call setup and teardown using any of the well-known VoIP protocols such as the Session Initiation Protocol (SIP), H.323, Inter-Asterisk Exchange (IAX2), Media Gateway Control Protocol (MGCP) or other similar protocols. If the telephone 110 is a standard analog telephone, the VoIP portion of communication device 120 would incorporate an analog telephone adapter (ATA), however, that is not meant to be limiting. As is the case with other VoIP devices, the communication device 120 may provide the telephone 110 with a dial tone, so that, upon picking up the receiver, the subscriber knows that the system is available for use. Once the user has dialed a telephone number or emergency code on the telephone 110, the dialing pulses are received by determination circuitry 210 in the communications device 120.

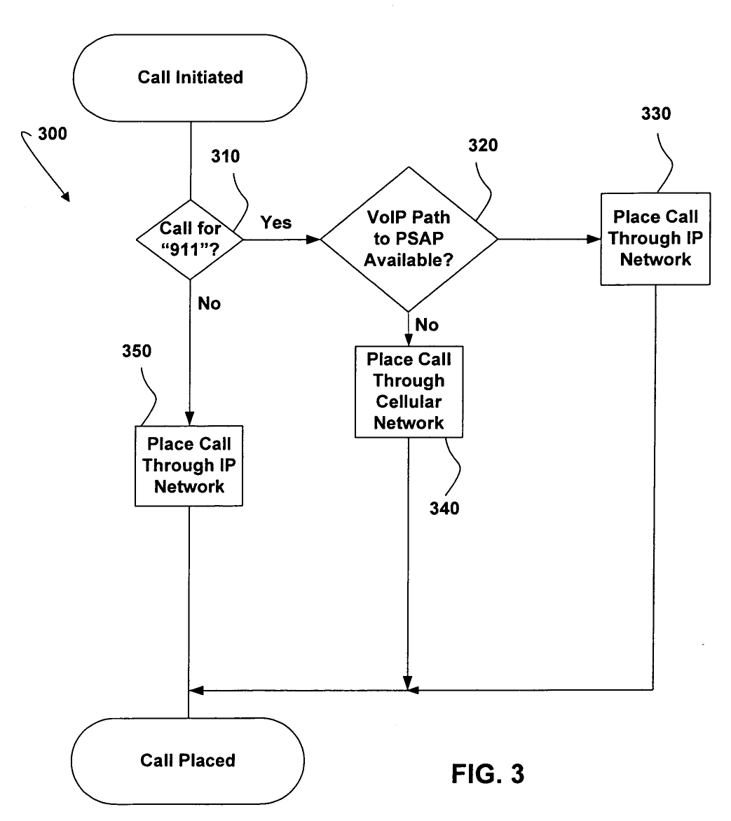

Based on certain determinations made by the determination circuitry 210 (examples of which will be discussed herebelow in connection with the embodiments of FIGS. 3-6), the determination circuitry 210 makes a determination as to whether the telephone call from the telephone device is to be placed over the IP network 130 or via the mobile network 140. If it is determined that the telephone call is to be placed over the IP network 130, the telephone call from the telephone 110 is sent to the VoIP circuitry 215 of the communication device 120. VoIP circuitry 215 may include an analog-to-digital converter (ADC) 220 with which analog voice data is sampled and digitized, as well as a VoIP encoder, for packetizing and encoding the digitized voice data into a standardized VoIP format. The VoIP circuitry 215 would initiate a session with a VoIP server, with which the telephone subscriber has an account, and the packetized voice telephone data would be routed and handled in accordance with the VoIP subscriber's plan. As such, a telephone call initiated from the VoIP subscriber's telephone 110 can be placed, via broadband, wired connections to the data network 130, and then to the VoIP servers affiliated with the subscriber (not shown), and from there, over the public telephone network to the ultimate destination. A call placed from the VoIP subscriber telephone 110 can be transferred at broadband or high speeds (i.e., high bit rates) across the data network 130, and place onto the public telephone network, in order to reach the ultimate intended telephone recipient.

If the determination circuitry 210 determines that the call should be placed over the alternate communications path, the call is routed to the mobile telephone network 140, via built-in mobile circuitry, such as the cellular circuitry 240, and built in antenna 250.

Once the call is placed to the PSAP, the PSAP may use known methods for determining the location of the caller. For example, known methods of cellular tower triangulation may be used to pinpoint the location of the communications device 120. Alternatively, GPS may be incorporated into the communication device 120, and used to relay information as to the location of the user to the PSAP. Further, if the subscriber is connected to the PSAP via the IP network, the VoIP service to which the user subscribes may have an address on file for use in such an occasion, or the location of the subscriber can otherwise be determined by their connection to the IP network.

Referring now to FIGS. 2 and 3, there is shown one embodiment of a method 300 for initiating a telephone call using a communication device, such as communication device 120 of FIG. 2. Using a telephone 110, the system subscriber initiates a telephone call by dialing a telephone number. The number is received by the determination circuitry 210. In the instant embodiment, the determination circuit 210 determines whether the call is for 911, the phantom number for emergency services. Step 310. If the determination circuitry 210 determines that the user has initiated an emergency call (i.e., to 911), the determination circuitry 210 determines whether the VoIP path to the PSAP is available. Step 320. If the determination circuitry 210 of FIG. 2 has made a determination that the VoIP path is available, in the instant embodiment, the determination circuitry 210 routes the call to the VoIP circuitry, which places the call through the IP network 130. Step 330. If the determination circuitry determines that the VoIP path to the PSAP is unavailable, the call is routed to the cellular circuitry 240, and the call is placed over the cellular/mobile network. Step 340. If the determination circuitry 210 determines that the initiated call is not requesting emergency service, in the instant embodiment, the call is placed through the IP network 130. Step 350.

Note that a failure in any link in the normal VoIP communications path between the VoIP device at the user's end, and the PSAP, can be used to determine that the VoIP path to the PSAP is unavailable. For example, the VoIP path may be determined to be unavailable if, among other possibilities, the IP network or network connection is determined to be down or of poor quality, the VoIP network or connection is determined to be down or of poor quality, the VoIP service and/or provider is down, unresponsive and/or otherwise unreachable. The above list is not meant to be limiting, as it is understood that certain other failures, including a determination of a failure of the VoIP circuitry in the device 120 of FIG. 2, can be used to determine that the VoIP path to the PSAP is unavailable.

Using the method 300, there is provided an alternate means to reach a “911” operator in the event that either: a) the VoIP service provider has no ability to complete a “911” call; or b) failure of the Internet or other computer network to which the communication device 120 is attached.

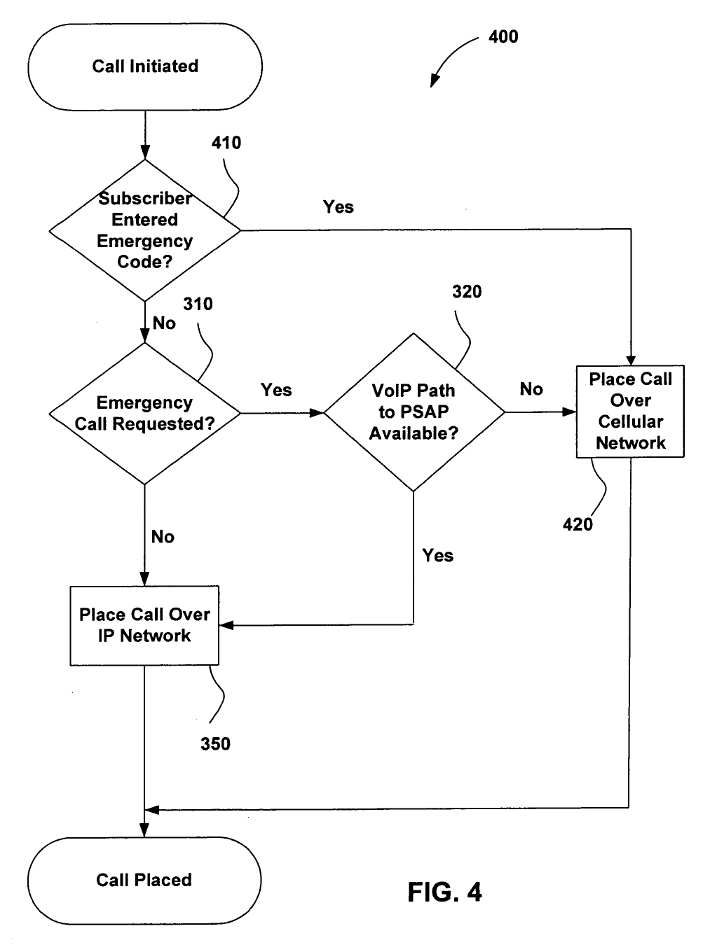

Additionally, it may be desirable to provide a special code which, when invoked by the subscriber, automatically bypasses any determination of whether to place the call over the IP network 130, in order to ensure that the call is placed over the alternate communications network. Such an embodiment will connect the subscriber to an emergency operator even if circuitry in the communication device cannot detect the failure of the SIP circuitry and/or IP network 130. Referring now to FIGS. 2 and 4, there is shown a method 400 of placing a telephone call, in accordance with another embodiment of the instant invention. In the method 400, once a call is initiated from the telephone 110, the determination circuitry 210, first, makes a determination whether the subscriber has entered a bypass code, for example, *911. Step 410. If such a bypass code is detected, the call is placed over the alternate communications network using the cellular circuitry 240, whether or not the VoIP path to the PSAP is available. Step 420. If the subscriber code is not detected as having been entered, the system can operate as described in method 300 of FIG. 3.

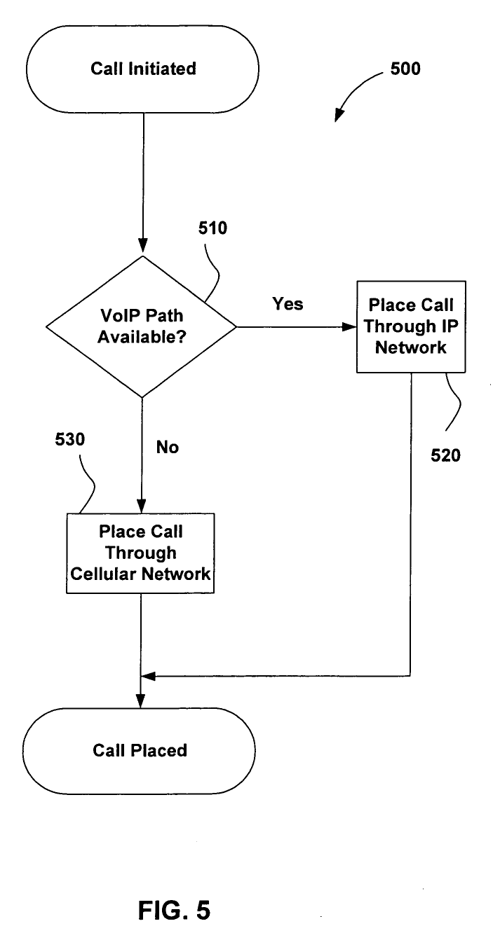

In another embodiment of the instant invention, the VoIP subscriber may also have an account on the cellular network. As such, the determination circuitry 210 of the communications device 120 may always be called upon to make a determination of VoIP path availability prior to placing a telephone call, and not just in cases of emergency. Referring now to FIGS. 2 and 5, there is shown a method 500 of placing a telephone call wherein the determination circuitry 210 makes a determination prior to placing any calls, as to the availability of the VoIP path. Step 510. In such a case, if the VoIP path is determined to be available, the telephone call is placed over the IP network. Step 520. Alternatively, the telephone call will be placed over the cellular network. Step 530. Using such a determination method, the telephone subscriber can be assured of placing a telephone call, while minimizing the usage of the cellular network.

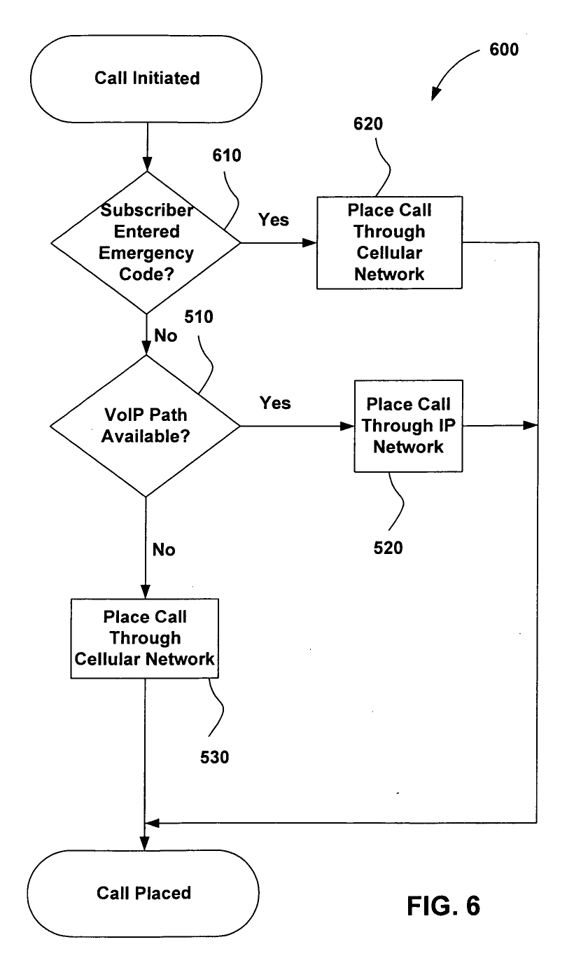

Referring now to FIG. 6, there is shown a method 600 of placing a call, wherein the determination circuitry 210 determines, first, if an emergency code has been entered by the subscriber, which code forces an emergency call to be placed over the cellular network. Steps 610 and 620. If no such code has been entered, the method 600 proceeds as described in connection with the method 500 of FIG. 5.

The foregoing invention can be used by a VoIP subscriber, to complete a telephone call, even in the event that any component that connects the telephone to the public Internet or other network fails. In certain described embodiments, the VoIP subscriber is provided added safety by ensuring at least two possible mechanisms to complete emergency telephone calls. The invention further ensures that the subscriber can reach emergency personnel, even if the IP network, itself, fails, such as would be the case in a natural disaster, such as tornado, heavy rainstorm, hurricane, etc.

Although the device has been shown and described as being a combined device, it is understood that the mobile network circuitry of present invention may be provided as an adjacent processor that works in coordination with an existing VoIP device.

I claim:

1. A method of placing a telephone call, comprising:
receiving an input from a telephone device requesting the placement of a telephone call;
determining whether the telephone call is to be placed over the Internet or over another communications network;
placing the telephone call over either the Internet or over the another communications network, based on the results of the determining step.

2. The method of claim 1, wherein, if the determining step determines that the telephone number entered is a request for emergency services, the determining step further determines whether a path including the Internet is currently available, and if the path is available, determines that the call should be placed over the Internet, and, if the path is not available, determines that the call should be placed over the another communications network.

3. The method of claim 2, wherein the determining step determines whether the input from the telephone device is a telephone number indicating a request for emergency services.

4. The method of claim 3, wherein the another communications network is the cellular telephone network.

5. The method of claim 2, wherein if the determining step determines that the input from the telephone device is a particular emergency code, the determining step determines that the call should be placed over the another communications network

6. The method of claim 5, wherein the another communications network is the cellular telephone network.

7. The method of claim 1, wherein, the determining step further determines whether the path including the Internet is currently available, and if the path is available, determines that the call should be placed over the Internet, and, if the path is not available, determines that the call should be placed over the another communications network.

8. A voice communications system for communication voice signals over a data network or a mobile telephone network, comprising
a telephone device for generating voice signals, said telephone device including a user interface for generating a user input;
a communications device for receiving said voice signals and providing said voice signals to either the data network or to the mobile telephone network;
said communications device including a determination module for determining whether the voice signals are to be placed over the data network or the mobile telephone network;
said communications device further including a VoIP module and a modem module, said VoIP module for encoding said voice signals for transmission over a data network and transmitting the encoded voice signals to the data network over a broadband connection, said modem module for transmitting said voice signals over the mobile telephone network; and
said voice signals being sent to said VoIP module or said modem module based on a determination from said determination module.

9. The method of claim 8, wherein, if said determination module determines that the user input entered is a request for emergency services, said determination module further determines whether a path including the data network is currently available, and if the path is available, determines that the call should be placed over the data network, and, if the path is unavailable, determines that the call should be placed over the mobile telephone network.

10. The system of claim 9, wherein said determination module determines whether the user input from the telephone device is a telephone number indicating a request for emergency services.

11. The method of claim 8, wherein if said determination module determines that the input from the telephone device is a particular emergency code, said determination module determines that the call should be placed over the mobile telephone network

12. The method of claim 8, wherein, said determination module further determines whether the path including the data network is currently available, and if the path is available, determines that the call should be placed over the data network, and, if the path is not available, determines that the call should be placed over the mobile telephone network.

13. A voice communications system, comprising
a telephone device for generating voice signals, said telephone device including a user interface for generating a user input;
a communications device for receiving said voice signals and providing said voice signals to either the Internet or to the cellular telephone network;
said communications device including a determination module for determining whether the voice signals are to be placed over the Internet or the cellular telephone network;
said communications device further including a VoIP module for encoding said voice signals for transmission over the Internet and transmitting the encoded voice signals to the Internet and a modem module for transmitting said voice signals over the cellular telephone network; and
said voice signals being sent to said VoIP module or said modem module based on a determination from said determination module.

14. The method of claim 13, wherein, if said determination module determines that the user input entered is a request for emergency services, said determination module further determines whether a path including the Internet is currently available, and if the path is available, determines that the call should be placed over the path including the Internet, and, if the path is not available, determines that the call should be placed over the cellular telephone network.

15. The system of claim 14, wherein said determination module determines whether the user input from the telephone device is a telephone number indicating a request for emergency services.

16. The method of claim 13, wherein if said determination module determines that the input from the telephone device is a particular emergency code, said determination module determines that the call should be placed over the cellular telephone network

17. The method of claim 13, wherein, said determination module further determines whether the a path including the Internet is currently available, and if the path including the Internet is available, determines that the call should be placed over the path, and, if the path including the Internet is not available, determines that the call should be placed over the cellular telephone network.
